(19) United States
(12) Patent Application Publication
(10) Pub. No.: US 2023/0362560 A1
(43) Pub. Date: Nov. 9, 2023

(54) SYSTEM AND METHOD FOR PERSONALIZED, IMAGE ANALYSIS BASED POSITIONING OF HEARING AIDS

(71) Applicant: TUNED LTD., Gan Yoshiya (IL)

(72) Inventors: Omri GAVISH, Gan Yoshiya (IL); Ron GANOT, Kfar Saba (IL)

(21) Appl. No.: 17/739,129

(22) Filed: May 8, 2022

(51) Int. Cl. H04R 25/00; G06V 40/16

(52) U.S. Cl. CPC H04R 25/603; G06V 40/167; G06V 40/171; H04R 25/40; H04R 2225/55

(57) ABSTRACT

System and method for personalized positioning of hearing aids in particular for in a home-setting, based on imaging and image processing.

### TECHNOLOGICAL FIELD

The present disclosure generally relates to a system and method for personalized positioning of hearing aids in particular for use in a home-setting, and specifically to personalized positioning of hearing aids, based on imaging and image processing.

### BACKGROUND

Proper hearing aid fitting is crucial for a successful hearing rehabilitation process. For BTE/RIC/RITE/Slim tube hearing aids, the appropriate position of the hearing, including the angle of the hearing aid, is essential to the efficiency of the directional microphone, which in turn is essential to in-noise hearing. Furthermore, proper insertion of the hearing aid tube/receiver in the ear canal is essential to efficient delivery of sounds into the ear canal as well as to avoiding possible acoustic feedback or avoiding wearing discomfort. In addition, proper insertion also reduces the visibility of the hearing aid, thereby minimizing the emotional reaction of the hearing aid user and reactions from social surroundings. Not least, proper insertion is necessary to avoid loss of the hearing aids during use.

Many first-time users experience difficulty in correctly inserting hearing aids, which may lead to loss of the hearing aid, lower sound quality, wearing discomfort, lack of proper amplification and especially impaired hearing in noisy environments, ultimately leading to low compliance and satisfaction.

There thus remains a need for a system and method for determining hearing aid positioning correctness and/or for guided insertion of the hearing aids.

### SUMMARY

There is provided herein a system and method for personalized fitting of hearing aids, which enable a hearing aid user to ensure correct insertion of his/her hearing aid, especially in a home-setting, without the assistance of a hearing care professional.

Advantageously, the herein disclosed system and method are based on imaging and image processing and thus enable providing a personalized guidance to the user, while taking into consideration the anatomy of the user's ear. This by calculating the position of different parts of the hearing aid relative to their optimal position vis-à-vis the user's ear.

According to some embodiments, the method also provides guided positioning of the hearing aid to the subject's ear, once again while taking into consideration the unique anatomy of the user's ear, so as to reduce misplacement up-front.

Advantageously, the herein disclosed system and method enable validated positioning of the hearing aid remotely from the user's hearing aid professional.

These and other objects of the invention are achieved by providing a computer implemented method for determining hearing aid positioning correctness, the method comprising: requesting, via a user interface, a hearing aid user to capture and/or upload a plurality of images, the plurality of images comprising at least one frontal face image and at least one side face image, wherein the plurality of images is captured while the user is wearing a hearing aid, processing the plurality of images to determine the position of to at least one anatomic landmark of the user's ear and of one or more parts of the hearing aid, wherein the processing comprises applying an image analysis algorithm on the plurality of images; determining the correctness of the position of hearing aid by applying a machine learning algorithm on one or more features related to a relative position of the hearing aid vis-à-vis the anatomic landmark of the user's ear; and providing an indication to the user regarding the correctness of the hearing aid position, wherein: if the position of the hearing aid is determined to be correct, provide an indication to the user that the hearing aid is correctly positioned; if the position of the hearing aid is determined to be incorrect, request the user to reposition the hearing aid and/or change a structural element of the hearing aid followed by a recapturing of the plurality of images.

In certain embodiments, the method further comprises extracting the at least one anatomic landmark of the user's ear, wherein the extracting comprises applying an image analysis algorithm on the plurality of images.

In certain embodiments, the at least one landmark comprises the climax of the helix, the angle of the pinna relative to the head, the crus of helix, the tragus, the intertragic notch, the antitragus, the entrance of the external auditory canal, the cavum and the d-shape of the pinna or any combination thereof.

In certain embodiments, the one or more features comprises one or more of: a distance between a climax of a helix of the subject's ear and a connection point between a body and a tube of the hearing aid, a horizontal and/or vertical distance between an upper band of the tube of the hearing aid and a crus of the helix of the subject's ear, a horizontal and/or vertical distance between a middle band of the tube of the hearing aid and the cymba of the subject's ear, a horizontal position of the hearing aid tube and/or a dome of the hearing aid relative to the concha and/or an entrance of an external auditory meatus of the subject's ear, a position of a lower part of the hearing aid tube in a vertical and/or horizontal plane relative to a tragus, antitragus and/or intertragic notch of the subjects ear.

In certain embodiments, the at least one side face image comprises at least one left-side face image and at least one right-side face image.

In certain embodiments, the plurality of images are still images.

In certain embodiments, the plurality of images are derived from a video.

In certain embodiments, the request to reposition the hearing aid comprises instruction regarding how to reposition.

In certain embodiments, the instructions comprises instructions to change an angle of the body of the hearing aid, instruction to position the hearing aid lower or higher than the current position, instruction regarding positioning of the wire/tube on the pinna, instructions regarding position and depth of the receiver/tube inside the ear and/or ear canal, instructions to change the dome of the hearing aid, instructions to change a length of the hearing aid tube and/or the receiver wire or any combination thereof.

In certain embodiments, the structural element is selected from a tube length, a tube depth, a standard silicon dome size, a standard silicon dome type, or a custom made earmold.

In certain embodiments, the method is executed via an App and wherein the capturing of the plurality of images is carried out using a camera of a mobile phone or tablet installed with the App.

In certain embodiments, the method further comprises guiding the capturing of the plurality of images.

In certain embodiments, the guiding comprises instructing the user to position the camera for capturing a frontal face image and determining correct face position relative to the camera's image frame by applying a face recognition tool.

In certain embodiments, the guiding further comprises instructing the user to turn the face sideways and determining correct face position based on automatic identification of the subject's ear.

In certain embodiments, the method further comprises an initial step of guided insertion/positioning of a hearing aid.

In certain embodiments, the machine learning algorithm is trained using a training set comprising: a large plurality of images of ears with hearing aids, a plurality of labels associated with the large plurality of images, each label indicating whether the hearing aid is correctly or incorrectly positioned.

In certain embodiments, the large plurality of images comprises at least two images of a same ear from different angles thereof.

In certain embodiments, the large plurality of images comprises images of ears of different subjects.

In certain embodiments, the large plurality of images comprises a first image of an ear with a correctly positioned hearing aid and a second image of the same ear with an incorrectly positioned hearing aid.

In certain embodiments, the method further comprises extracting a plurality of features from each of the large plurality of images.

In certain embodiments, the method further comprises selecting a subset of features from the plurality of features, which subset have a predictive value above a predetermined threshold.

Other objects are achieved by providing a system for determining hearing aid positioning correctness, the system comprising a processing logic configured to: request a hearing aid user to capture a plurality of images, the plurality of images comprising at least one frontal face image and at least one side face image, process the plurality of images to determine the position of at least one anatomic landmarks of the user's ear and of one or more parts of the hearing aid, wherein the processing comprises applying an image analysis algorithm on the plurality of images; determine the correctness of the position of the hearing aid by applying a machine learning algorithm on one or more features related to a relative position of the hearing aid vis-à-vis the anatomic landmark of the user's ear; and provide an indication to the user regarding the correctness of the hearing aid position, wherein: if the position of the hearing aid is determined to be correct, provide an indication to the user that the hearing aid is correctly positioned; if the position of the hearing aid is determined to be incorrect, request the user to reposition the hearing aid and/or change a structural element of the hearing aid followed by a recapturing of the plurality of images.

Other objects are achieved by providing a system that practices the methods claimed herein.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In block diagrams and flowcharts, certain steps may be conducted in the indicated order only, while others may be conducted before a previous step, after a subsequent step or simultaneously with another step. Such changes to the orders of the step will be evident for the skilled artisan.

FIG. 1 is an illustration of the herein disclosed method/system for verifying correct hearing aid positioning, according to some embodiments.

FIG. 2 is a flow chart of the herein disclosed computer implemented method for verifying correct hearing aid positioning, according to some embodiments.

FIG. 3 is an illustrative image of a hearing aid and its parts.

FIG. 4 is an illustrative image for guided distinguishing between a left and right hearing aid.

FIG. 5-FIG. 12, are illustrative images visualizing the steps for insertion of a right hearing aid.

FIG. 13-FIG. 19, are illustrative images visualizing the steps for insertion of a left hearing aid.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

According to some embodiments, there is provided a computer implemented method for determining hearing aid positioning correctness (and system for implementation of same), the method including: requesting, via a user interface (e.g. a dedicated mobile App), a hearing aid user to capture and/or upload a plurality of images, the images captured, while the user is wearing his/her hearing aid, processing the plurality of images to determine the position of one or more parts of the hearing aid relative to at least one anatomic landmarks of the user's ear, wherein the processing comprises applying an image analysis algorithm on the plurality of images; determining the correctness of the position of hearing aid by applying a trained machine learning algorithm on the determined position of the hearing aid relative to the anatomic landmark of the user's ear; and providing an indication to the user (e.g. via the App interface) regarding the correctness of the hearing aid position.

According to some embodiments, if the position of the hearing aid is determined to be correct, the indication provided may signal to the user that the hearing aid is correctly positioned. Non-limiting examples of suitable signals/indication is a text message, a message provided through the hearing aid, a sound provided through the hearing aid, an indicator (e.g. a green light) provided through the App or any other suitable signal or combination of signals. Each possibility is a separate embodiment.

Alternatively, if the position of the hearing aid is determined to be incorrect, the indication provided may signal to the user that the hearing aid is incorrectly positioned. Non-limiting examples of suitable signals/indication is a text message, a message provided through the hearing aid, a sound provided through the hearing aid, an indicator (e.g. a red light) provided through the App or any other suitable signal or combination of signals. Each possibility is a separate embodiment. According to some embodiments, in addition to or instead of the signal, a request may be provided to the user (via the App and/or via the hearing aid) to reposition the hearing aid and/or to change a structural element of the hearing aid, optionally followed by a recapturing of the plurality of images.

According to some embodiments, the request to reposition the hearing aid may include providing vocal and/or visual instruction regarding how to reposition the hearing aid or parts thereof. According to some embodiments, the instructions may include instructions to change an angle of the body of the hearing aid, instruction to position the hearing aid body lower or higher than the current position, instruction regarding positioning of the wire/tube on the pinna, instructions regarding position and depth of the receiver/tube inside the ear and/or ear canal, instructions to change the dome of the hearing aid, instructions to change a length of the hearing aid tube and/or the receiver wire or any combination thereof. Each possibility is a separate embodiment.

According to some embodiments, the change in the structural element may be a change in the length of the hearing aid tube, the diameter of the hearing aid tube, the depth of the hearing aid tube, a change in the hearing aid dome utilized, such as, but not limited to, changing the size of the hearing aid dome (e.g. from a plurality of standard sizes), changing the type of the hearing aid dome (e.g. from a plurality of standard dome types), or changing to a custom made earmold. Each possibility is a separate embodiment.

As used herein, the term “hearing aid,” refers to all types of hearing enhancement devices, including medical devices prescribed for the hearing impaired, and personal sound amplification products (PSAP) generally not requiring a prescription or a medical waiver. The device type or “style” may be any of invisible in the canal (IIC), in-the-canal (ITC), in the ear (ITE), a receiver in the canal (RIC), or behind the ear (BTE). A canal hearing device refers herein to any device partially or fully inserted in the ear canal.

As used herein, the terms “mobile application” and “App” may be used interchangeably and refer to a computer program or software application designed to run on a mobile device such as a phone, tablet, and/or watch.

As used herein, the term “plurality” with regards to the number of images captured and/or uploaded may include 2, 3, 4, 5, 6, 7, 8, 9, 10 or more images. Each possibility is a separate embodiment.

As used herein the term “processing” with regards to analyzing the plurality of images to determine the position of one or more parts of the hearing aid and at least one biometric feature and/or anatomic landmarks of the user's ear, refers or includes applying an image analysis algorithm on the plurality of images. According to some embodiments, the image analysis comprises three main steps:
Step 1: Localize the face in the image.
Step 2: Detect the ear(s) in the localized face.
Step 3: Detect anatomical landmarks of the ear.
Step 4: Detect the hearing aid and the hearing aid's parts on the ear.

According to some embodiments, localizing the face in the image comprises applying face detection algorithms, such as, but not limited to, a pre-trained HOG+Linear SVM object detector specifically for the task of face detection. According to some embodiments, localizing the face in the image comprises applying deep learning-based algorithms for face localization. According to some embodiments, localizing the face in the image comprises determining the (x, y)-coordinates of the face in the image.

According to some embodiments, detecting the ear(s) in the image comprises applying a facial landmark algorithm/detector. According to some embodiments, detecting the ear(s) in the image comprises using a training set of labeled ears in a large plurality of images. These images are manually labeled, specifying specific (x, y)-coordinates of regions surrounding the ear. Given this training data, a machine learning algorithm such as, but not limited to, an ensemble of regression trees may be trained to detect a subject's ear(s). Once the training is completed, the algorithm may be applied to detect the ear in unknown images with high quality predictions.

It is understood that similar methods may be applied to identify anatomies/landmarks of the ear. That is, once the ear is detected and x,y coordinates provided, the machine learning algorithm may be trained to identify any of various anatomical landmarks of the ear. As used herein, the terms “anatomical landmark”, “anatomical fiducial”, “anatomy of the ear” and “biometric feature” may be used interchangeably and refer to substructures of the human ear such as, but not limited to, the climax of the helix, the angle of the pinna relative to the head, the crus of helix, the tragus, the intertragic notch, the antitragus, the entrance of the external auditory canal, the cavum, the −d-shape of the pinna or any combination thereof. Each possibility is a separate embodiment. Once the training is completed, the algorithm may be applied to detect not only the ear, but also the anatomical landmarks of the ear in unknown images.

According to some embodiments, same or similar machine learning algorithms may be applied for detection of the hearing aid worn by the user as well as parts thereof. In this case the training data includes a large plurality of images with labeling of the hearing aid and/or its parts, such as, but not limited to, the body of the hearing aid, the hearing aid tube, the connection element connecting between the hearing aid body and the hearing aid tube, the upper band of the tube, the lower band of the tube, the retainer of the tube, the silicone dome or any combination thereof. Each possibility is a separate embodiment.

It is understood, that since the ears are positioned on the side of the subject's head, the large plurality of images on which the training of the machine learning algorithm is performed and/or the images captured/uploaded may include at least one frontal face image and at least one side face image. According to some embodiments, when the user is wearing hearing aids on both ears, the plurality of images may include at least one frontal face image, at least one right-side image and at least one left-side image.

According to some embodiments, the large plurality of images on which the training of the machine learning algorithm is performed and/or the images captured/uploaded may be still images and/or image frames derived from a video.

According to some embodiments, the images captured and/or uploaded may be captured using the camera of a mobile phone or tablet installed with the App.

According to some embodiments, the method may further include guiding the capturing of the plurality of images. According to some embodiments, the guiding comprises instructing the user to position the camera for capturing a frontal face image and determining correct face position relative to the camera's image frame by applying a face recognition tool, which may be custom made to the App or part of the normal face detection of mobile cameras. According to some embodiments, the custom-made face detection tool for the capturing of the images may be configured to ensure that the ear, and optionally particular landmarks thereof, is seen in the image. According to some embodiments, the face detection tool utilized for the capturing of the images may be part of the herein described image analysis algorithms. According to some embodiments, the guiding further comprises instructing the user to turn the face sideways and determining correct face position, e.g. based on automatic identification of the subject's ear.

As used herein, the term “large plurality” with regards to the number of images utilized during the training of the one or more machine learning algorithms applied may refer to at least 100 images, at least 200 images, at least 500 images, at least 1000 images, or at least 2000 images.

According to some embodiments, the images include at least two images of a same ear from different angles thereof (e.g. from the side, from the front and optionally also from the back).

According to some embodiments, the images include images of ears of different subjects.

According to some embodiments, the images include images of same subjects (same or different) wearing different hearing aids.

According to some embodiments, the images include a first subset of images of ear(s) with a correctly positioned hearing aid and a second subset of images of the same ear(s) with an incorrectly positioned hearing aid.

According to some embodiments, the determining of the correctness of the position of the hearing aid by applying a machine learning algorithm on the determined position of the hearing aid and the anatomic landmark of the user's ear comprises extracting features from the images such as, but not limited to, features regarding a relative distance and/or relative placement of the determined location of the hearing aid and/or relevant parts thereof vis-à-vis the anatomical landmark of the ear. Non-limiting examples of suitable features for extraction include: a distance between the climax of the helix and a connection point between a body and tube of the hearing aid; horizontal and/or vertical distances between an upper band of a tube of the hearing aid and the crus of the helix; horizontal and/or vertical distances between the middle band of a tube of the hearing aid and the cymba; the horizontal position of the tube and/or hearing aid dome relative to the concha and/or the entrance of the external auditory meatus; the position of the lower part of the tube in the vertical and horizontal plane relative to the tragus, antitragus and/or intertragic notch or any combination thereof. Each possibility is a separate embodiment.

According to some embodiments, the determining of the correctness of the subject's ear comprises applying a machine learning algorithm (same or different than that used for the ear detection and/or hearing aid detection), also referred to herein as the “correctness-of-positioning detector” or “classifier”. According to some embodiments, the machine learning algorithm applied was trained on a training set comprising: a large plurality of images of ears with hearing aids and/or coordinates indicative thereof, and a plurality of labels associated with the large plurality of images (and/or the coordinates), each label indicating whether the hearing aid is correctly or incorrectly positioned.

Non-limiting examples of suitable classifier algorithms include: logistic regression algorithms, Naive Bayes algorithms, K-Nearest Neighbors algorithms, Decision Tree algorithms, Support Vector Machines algorithms or any combination thereof. Each possibility is a separate embodiment.

According to some embodiments, applying the “correctness-of-positioning detector/classifier” comprises extracting a plurality of features from each of the large plurality of images. According to some embodiments, applying the “correctness-of-positioning detector” further comprises selecting a subset of features from the plurality of extracted features, which subset have a predictive value above a predetermined threshold.

According to some embodiments, the method may include a step of uploading the images to a cloud, wherein the processing of the plurality of images and/or the determining of the correctness of the position of hearing aid is/are performed in the cloud. It is understood that the “in-cloud” processing/analysis can significantly reduce the computational load required, which may be of significance in the elderly population who often is in possession of older computational devices (whether PCs or smartphones).

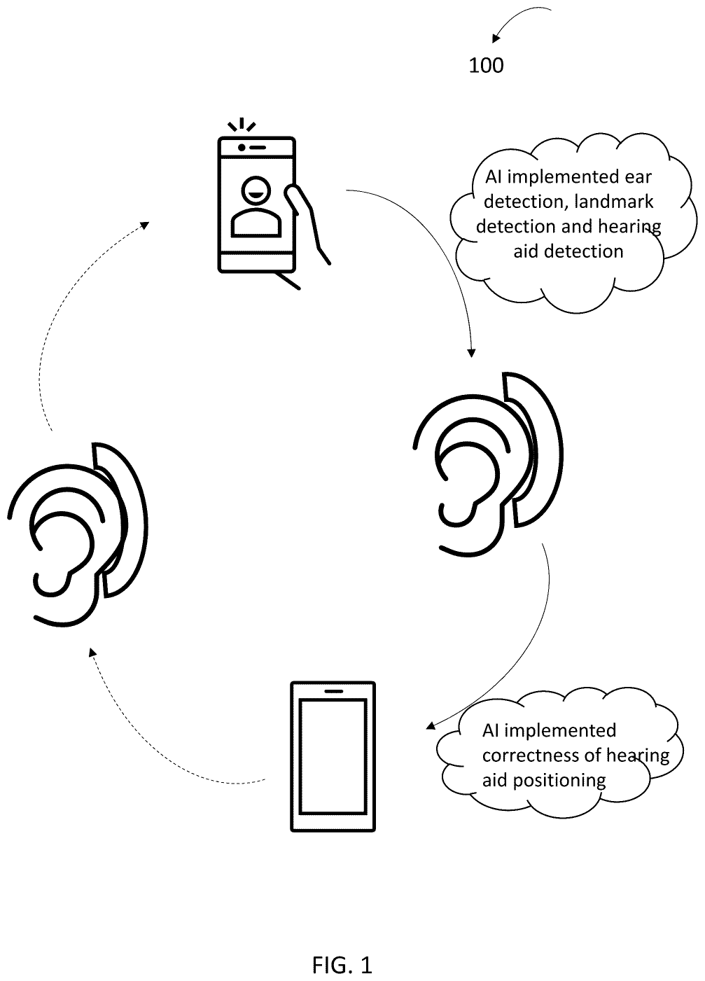

Reference is now made to FIG. 1, which illustratively depicts the herein disclosed method/system 100 for verifying correct hearing aid positioning, according to some embodiments.

Initially a hearing aid user is requested, e.g. via a user interface of a dedicated mobile App, to capture and/or to upload at least one frontal face image and at least one side face image, while wearing his/her hearing aid. It is understood that the image capturing may be done as a selfie or by another subject. Optionally, the App may include a feature of assisted image capturing. For example, the App may initially guide the user to position the camera and/or his head to frame the face in such manner that the ears are visible for when capturing the frontal face image, by applying a face recognition tool, as essentially described herein. The App may then guide the user to position the camera and/or his head to frame the face in such a way that the entire ear is visible for when capturing the frontal face image, by applying a face recognition tool, as essentially described herein. Optionally, when the user is wearing a hearing aid in both his ears the side image capturing may be repeated for the other side.

It is understood that the order of the image capturing may be opposite such that initially side images are captured and then frontal. Similarly, the number of images required in each position may vary from user to user, for example due to differences in the quality of the images captured (e.g. as a result of differences in camera quality, user position, user stillness etc.)

Once the image capturing and/or image uploading (of previously acquired images) is completed, the images may be processed to extract, identify and/or measure at least one anatomic landmark of the user's ear and to identify the position of one or more parts of the hearing aid, wherein the processing comprises applying an image analysis algorithm on the plurality of images, as essentially described herein. According to some embodiments, the processing may be executed by the processing circuit of a mobile device, table or personal computer/laptop. Alternatively, the images may be uploaded to a cloud for processing in order to reduce the computational load on the user's device.

Based on the extracted, identified and/or measured landmark(s) and the identified position of relevant parts of the hearing aid, the correctness of the position of the hearing aid part is determined e.g. based on the features such as the relative position of the hearing aid parts to one or more landmarks relevant thereto, by applying a trained machine learning algorithm, as essentially described herein. According to some embodiments, if the initial processing is performed on the mobile device, the identified anatomical landmarks and device parts and/or the features extracted and/or measured therefrom may be sent to a cloud for further processing and classification. Alternatively, the entire processing may be carried out by the App or at the cloud in its entirety.

Once the correctness of the hearing aid position is determined, the App may provide/issue an indication to the user regarding same. Non-limiting examples of suitable indications include: a written message, a visual marker or audio message provided via the hearing aid, an audial signal provided via the hearing or any combination thereof. Each possibility is a separate embodiment.

According to some embodiments, if the position of the hearing aid is determined to be correct, the indication reflects same. Alternatively, if the position of the hearing aid is determined to be incorrect, the indication may be a request to the user to reposition the hearing aid and/or to change a structural element of the hearing aid followed by a recapturing of the plurality of images.

According to some embodiments, the request to reposition the hearing aid may be in the form of instruction (visual and/or audial) regarding how to reposition. For example, the instructions may be to change an angle of the body of the hearing aid, to position the hearing aid lower or higher than the current position, instruction regarding positioning of the wire/tube on the pinna, instructions regarding position and depth of the receiver/tube inside the ear and/or ear canal. Optionally, the guided positioning may be continuous. For example, when the user is instructed to position the hearing aid lower or higher than the current position, the guidance may issue messages (audial or visual) such as “more” “less” or sounds or markers (red light, green like or the like) in a continuous manner until a correct position is achieved.

According to some embodiments, in case the user is instructed/recommended to change a structural element of the hearing aid, such instructions can be to change the dome of the hearing aid (from other standard domes having different size and/or shape or to a custom-made dome), instructions to change a length of the hearing aid tube and/or the receiver wire (again from other standard tubes/receiver wires or to a custom-made hearing aid tube/receiver wire) or any combination thereof. Each possibility is a separate embodiment.

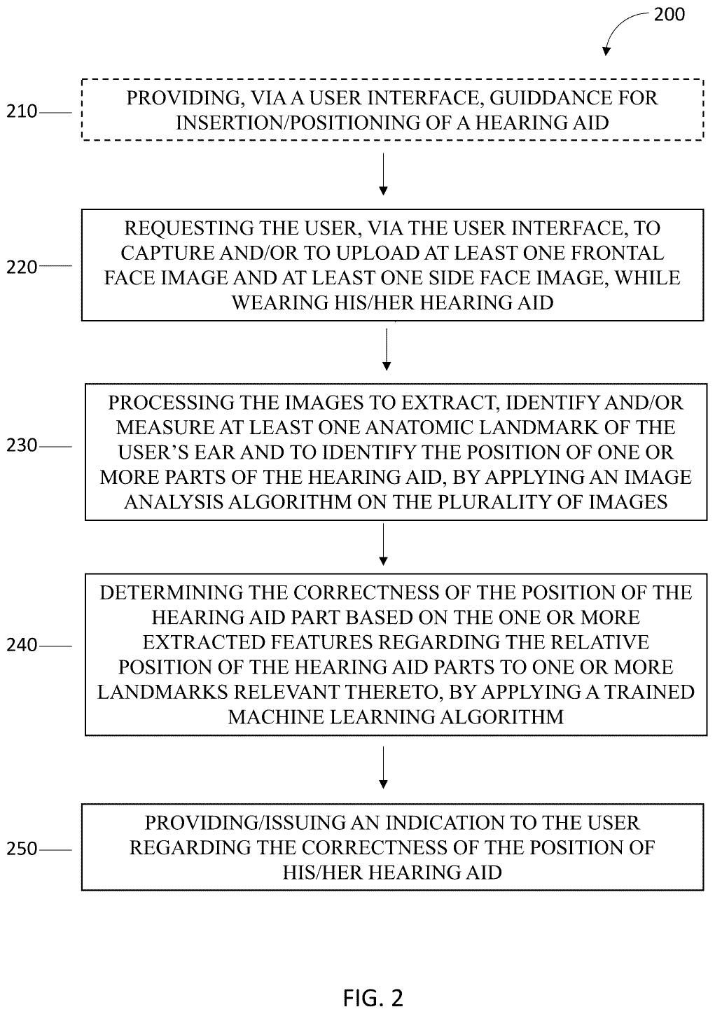

Reference is now made to FIG. 2, which is a flow chart 200 of the herein disclosed computer implemented method for verifying correct hearing aid positioning, according to some embodiments.

In step 210 (optional), a guided insertion/positioning of a hearing aid may be provided. According to some embodiments, the herein disclosed App for determining the correctness of hearing aid position may include a separate feature providing guided insertion/positioning of the hearing aid. According to some embodiments, a separate, dedicated “guided-positioning” App may be provided, which App is directed to provide guided insertion/positioning of a hearing aid.

In step 220, the hearing aid user may be requested, e.g. via a user interface of a dedicated mobile App, to capture and/or to upload at least one frontal face image and at least one side face image, while wearing his/her hearing aid.

It is understood that the image capturing may be done as a selfie or by another subject, as essentially described herein. According to some embodiments, the App may include a feature of assisted image capturing. For example, the App may initially guide the user to position the camera and/or his head to frame the face in such manner that the ears are visible for when capturing the frontal face image, by applying a face recognition tool, as essentially described herein. The App may then guide the user to position the camera and/or his head to frame the face in such a way that the entire ear is visible for when capturing the frontal face image, by applying a face recognition tool, as essentially described herein. According to some embodiments, the guided insertion/positioning may include illustrations, images and/or videos. Each possibility is a separate embodiment.

Next, in step 230, the images are processed to extract, identify and/or measure at least one anatomic landmark of the user's ear and to identify the position of one or more parts of the hearing aid, by applying an image analysis algorithm on the plurality of images, as essentially described herein.

According to some embodiments, the at least one anatomic landmark extracted, identified and/or measured is selected from the climax of the helix, the angle of the pinna relative to the head, the crus of helix, the tragus, the intertragic notch, the antitragus, the entrance of the external auditory canal, the cavum and the d-shape of the pinna or any combination thereof.

According to some embodiments, the one or more parts of the hearing aid is selected from the body of the hearing aid, the hearing aid tube, the connection element connecting between the hearing aid body and the hearing aid tube, the upper band of the tube, the lower band of the tube, the retainer of the tube, the silicone dome or any combination thereof. Each possibility is a separate embodiment

In step 240, the correctness of the position of the hearing aid part is determined, e.g. based on the one or more extracted features, such as the relative position of the hearing aid parts to one or more anatomical landmarks of the user's ear, relevant thereto, by applying a trained machine learning algorithm, as essentially described herein.

According to some embodiments, the one or more extracted features is selected from: a distance between a climax of a helix of the subject's ear and a connection point between a body and a tube of the hearing aid, a horizontal and/or vertical distance between an upper band of the tube of the hearing aid and a crus of the helix of the subject's ear, a horizontal and/or vertical distance between a middle band of the tube of the hearing aid and the cymba of the subject's ear, a horizontal position of the hearing aid tube and/or a dome of the hearing aid relative to the concha and/or an entrance of an external auditory meatus of the subject's ear, a position of a lower part of the hearing aid tube in a vertical and/or horizontal plane relative to a tragus, antitragus and/or intertragic notch of the subjects ear, the body of the hearing aid, the hearing aid tube, the connection element connecting between the hearing aid body and the hearing aid tube, the upper band of the tube, the lower band of the tube, the retainer of the tube, the silicone dome or any combination thereof. Each possibility is a separate embodiment.

In step 250, the App may provide/issue an indication to the user regarding the correctness of the position of the hearing aid. According to some embodiments, the indication may be in the form of a written message, a visual marker or audio message provided via the hearing aid, an audial signal provided via the hearing or any combination thereof. Each possibility is a separate embodiment.

According to some embodiments, if the position of the hearing aid is determined to be correct, the indication reflects same. Alternatively, if the position of the hearing aid is determined to be incorrect, the indication may be a request to the user to reposition the hearing aid and/or to change a structural element of the hearing aid followed by a recapturing of the plurality of images.

According to some embodiments, the request to reposition the hearing aid may be in the form of instruction (visual and/or audial) regarding how to reposition. For example, the instructions may be to change an angle of the body of the hearing aid, to position the hearing aid lower or higher than the current position, instruction regarding positioning of the wire/tube on the pinna, instructions regarding position and depth of the receiver/tube inside the ear and/or ear canal. Optionally, the guided positioning may be continuous. For example, when the instructions are to position the hearing aid lower or higher than the current position, the guidance may issue messages (audial or visual) such as “more” “less” or sounds or markers (red light, green like or the like) until a correct position is achieved.

According to some embodiments, the request to change a structural element, may be to change the dome of the hearing aid (from other standard domes having different size and/or shape or to a custom-made dome), instructions to change a length of the hearing aid tube and/or the receiver wire (standard or custom made) or any combination thereof.

According to some embodiments, there is provided a method for guided insertion/positioning of a hearing aid. According to some embodiments, the method may be a separate feature of the herein disclosed App for providing guided insertion/positioning of a hearing aid. According to some embodiments, a separate App is provided, which App is dedicated to providing guided insertion/positioning of a hearing aid.

According to some embodiments, the guided insertion/positioning may include illustrations, images and/or videos. Each possibility is a separate embodiment.

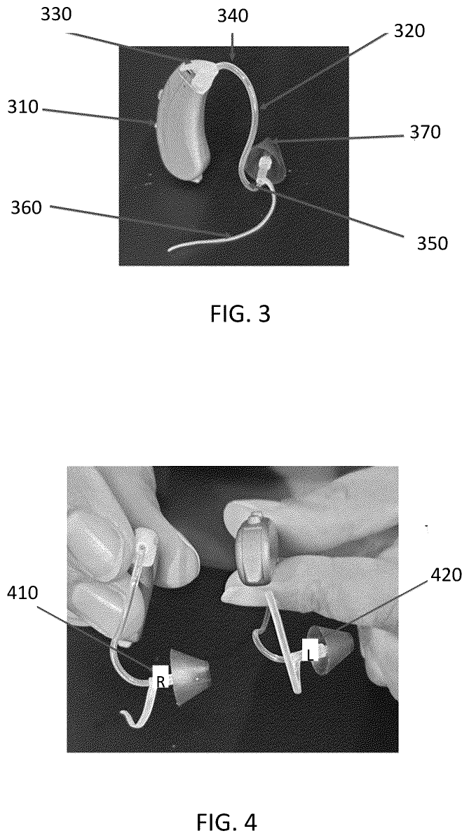

According to some embodiments, the guided insertion/positioning of a hearing aid may include visuals of the different hearing aid parts, as illustrated in FIG. 3.
310: The body of the hearing aid
320: Hearing aid tube.
330: Connection point of the body and the tube of the hearing aid.
340: First upper band of the hearing tube:
350: lower band of the hearing tube.
360: Retainer of the hearing tube.
370: Hearing aid dome.

According to some embodiments, the guided insertion/positioning of a hearing aid may include visual and/or textual guidance to distinguishing between a left and right hearing aid. Typically, the right hearing aid is signed by a red indicator or the letter R 410 on the hearing aid or on the tube of the hearing aid, and the left hearing aid is signed by a blue indicator or the letter L 420 on the hearing aid or on the tube of the hearing aid, as shown in FIG. 4.

According to some embodiments, the guided insertion/positioning may include visuals providing a step-wise guide to the positioning of the hearing aid. According to some embodiments, the steps may include some or all of the below described steps. According to some embodiments, the step-wise guide may include both text and visuals, such as, but not limited to, the below described steps and accompanying figures.

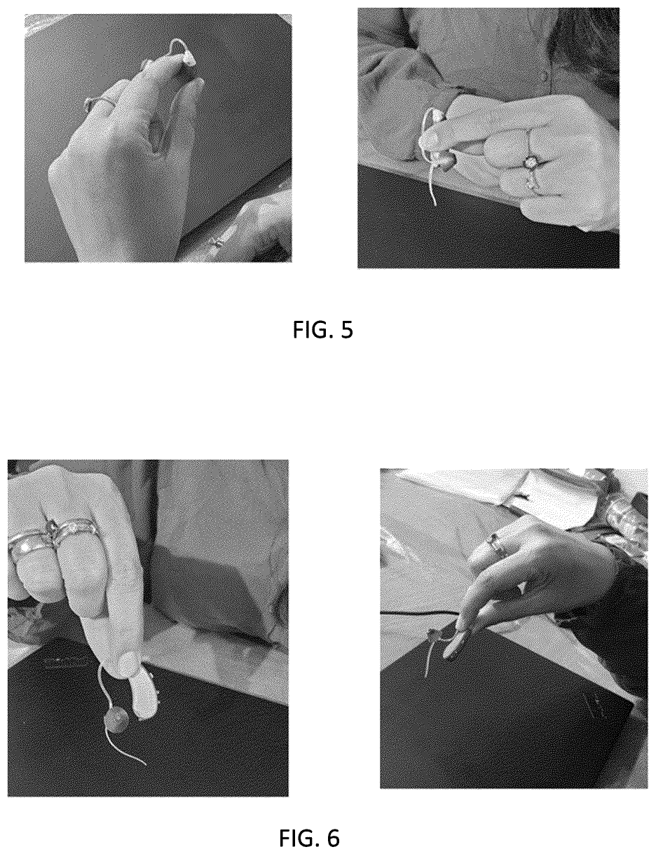

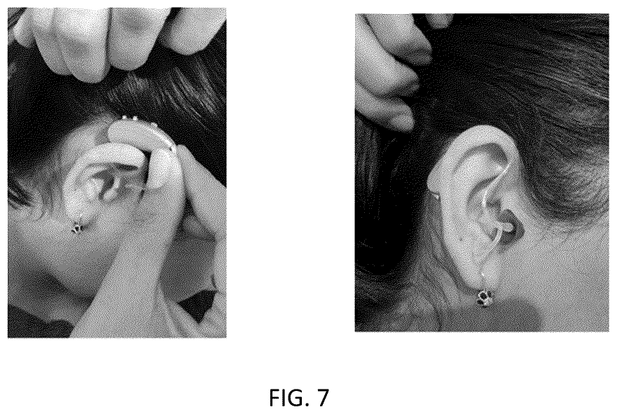

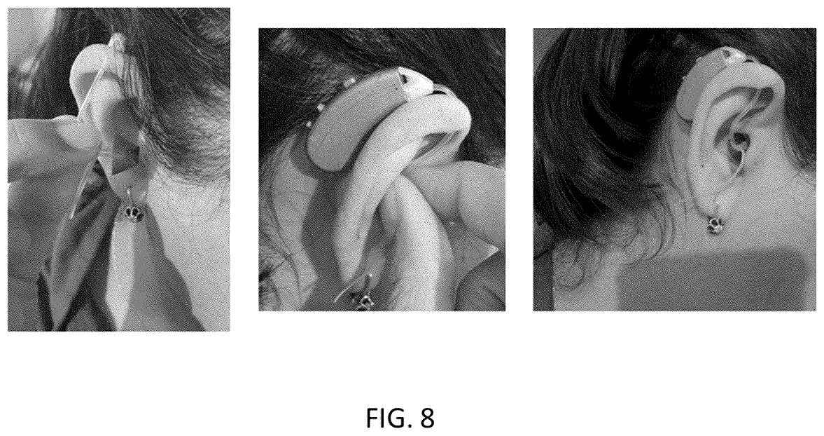

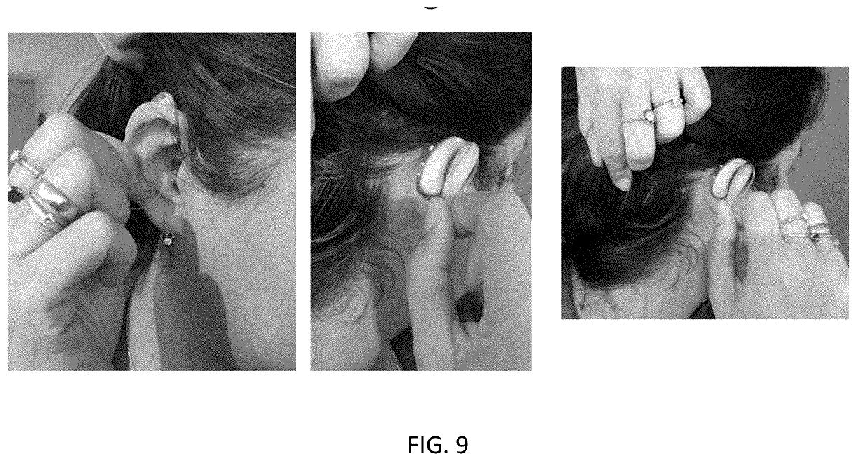

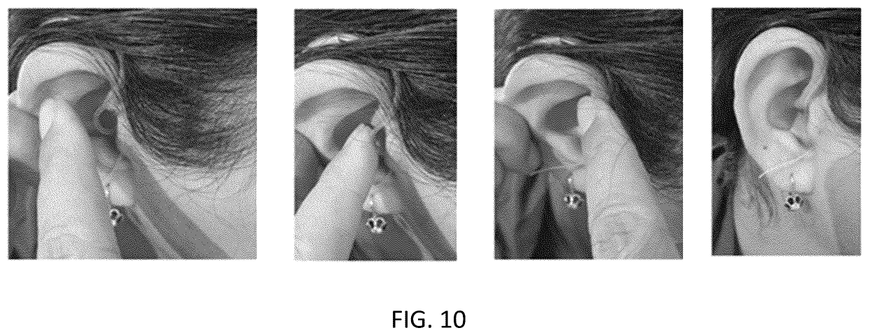

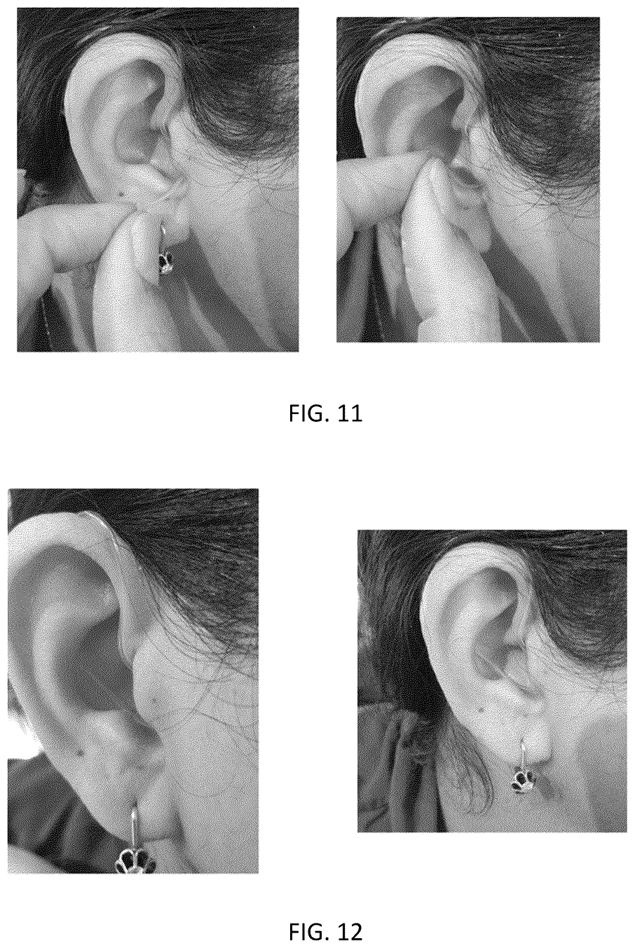

Reference is now made to FIG. 5-12, which are images visualizing the steps for insertion of right hearing aid:
Step 1: With your non-dominant hand, hold the right HA body so that when it is directed to your torso the tube is to the front (opposite side of the body)—FIG. 5.
Step 2: Use the index and the thumb fingers of your dominant hand and grab the upper part of the right hearing aid, where it connects with the tube. Release the non-dominant hand. The hearing aid body should be directed toward your body—FIG. 6.
Step 3: Locate the body of the hearing aid behind the right ear, the upper curve of the tube should be worn on the edge of the pinna—FIG. 7.
Step 4: Hold the lower curve of the tube and position the silicone dome at the entrance of the ear canal—FIG. 8.
Step 5: With the index and thumb of the right hand, grab the middle part of the pinna, pull backwards and keep it stretched—FIG. 9.
Step 6: Use the index finger of the left hand to slowly push the lower curve of the tube and the silicone dome as deep as possible into the ear canal—FIG. 10.
Step 7: Release the hands from the ear and hold the retainer and put it in your ear—FIG. 11.
Step 8: At the end of the insertion process, the tube should be attached to the pinna and should not pop out of the ear. You can use a mirror to observe that—FIG. 12.

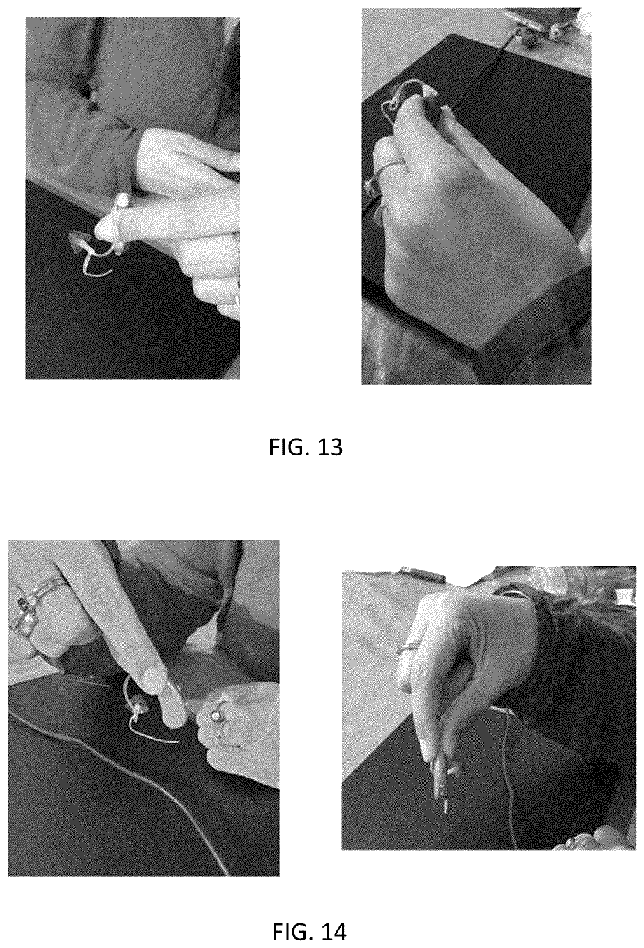

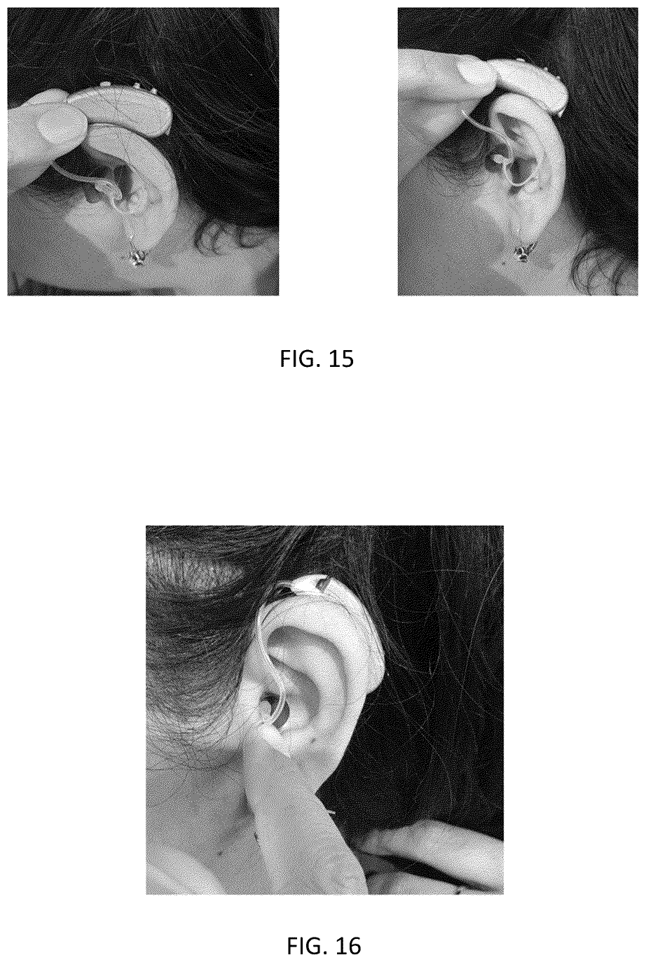

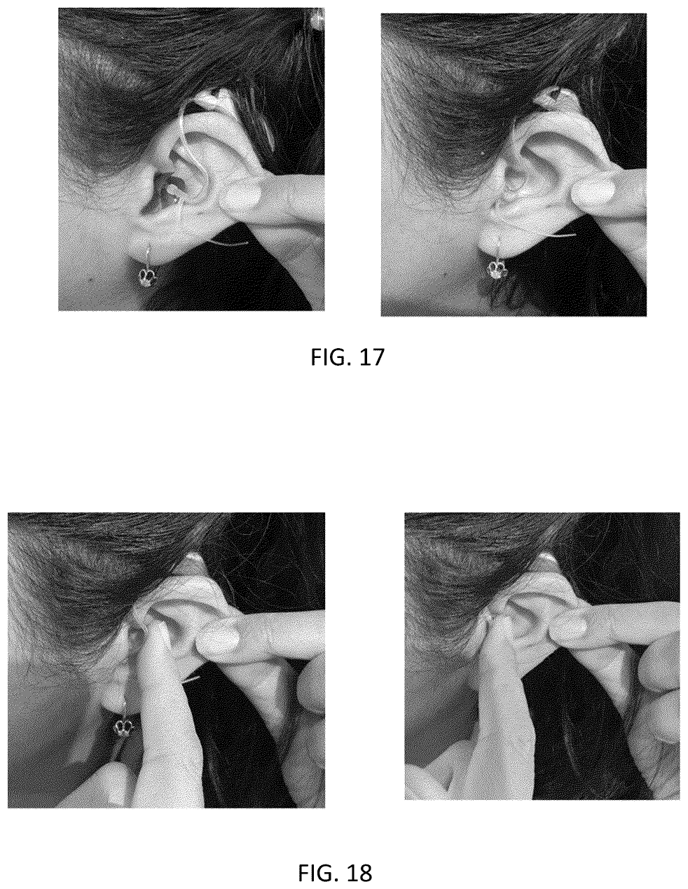

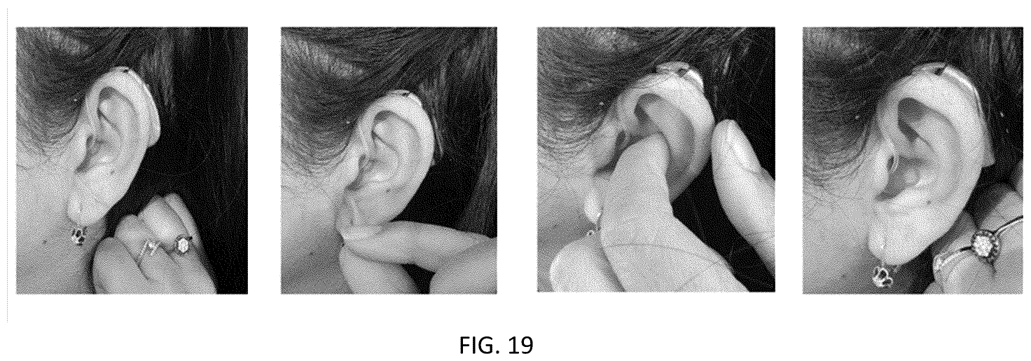

Reference is now made to FIG. 13-19, which are images visualizing the steps:
Step 1: With your non-dominant hand, hold the left HA body so that when it is directed to your torso the tube is to the front (opposite side of the body)—FIG. 13.
Step 2: Use the index and the thumb fingers of your dominant hand and grab the upper part of the hearing aid where it connects with the tube. Release the non-dominant hand—FIG. 14.
Step 3: Locate the body of the hearing aid behind the left ear, the upper curve of the tube should be worn on the edge of the pinna—FIG. 15.
Step 4: Hold the lower curve of the tube and position the silicone dome at the entrance of the ear canal—FIG. 16.
Step 5: With the index and thumb of the left hand, grab the middle part of the pinna, pull it backwards and keep it stretched—FIG. 17.
Step 6: Use the index finger of the right hand to slowly push the lower curve of the tube and the silicone dome as deep as possible into the ear canal—FIG. 18.
Step 7: Release the hands from the ear.
Step 8: At the end of the insertion process the tube should be attached to the pinna and should not pop out of the ear—FIG. 19.

For convenience, certain terms used in the specification, examples, and appended claims are collected here. Unless otherwise defined, all technical and scientific terms used herein have the same meaning as commonly understood by one of ordinary skills in the art to which this invention pertains.

As used herein, the term “personalized” in the context of the herein disclosed system and method/platform for hearing aid adjustment refers to a system and method/platform for hearing aid adjustment, which is configured to meet the hearing aid user's individual requirement, based on his/her perceived hearing experience.

As used herein, the terms “approximately”, “essentially” and “about” in reference to a number are generally taken to include numbers that fall within a range of 5% or in the range of 1% in either direction (greater than or less than) the number unless otherwise stated or otherwise evident from the context (except where such number would exceed 100% of a possible value). Where ranges are stated, the endpoints are included within the range unless otherwise stated or otherwise evident from the context.

As used herein, the singular forms “a,” “an” and “the” include plural referents unless the context clearly dictates otherwise.

As used herein, “optional” or “optionally” means that the subsequently described event or circumstance does or does not occur, and that the description includes instances where said event or circumstance occurs and instances where it does not.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods, according to some embodiments, may be described in a specific sequence, the methods of the disclosure may include some or all of the described stages carried out in a different order. In particular, it is to be understood that the order of stages and sub-stages of any of the described methods may be reordered unless the context clearly dictates otherwise, for example, when a latter stage requires as input an output of a former stage or when a latter stage requires a product of a former stage. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications, and variations that are apparent to those skilled in the art may exist. Accordingly, the disclosure embraces all such alternatives, modifications, and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

1. A computer implemented method for determining hearing aid position correctness, the method comprising:
requesting, via a user interface, a hearing aid user to capture and/or upload a plurality of images, the plurality of images comprising at least one frontal face image and at least one side face image, wherein the plurality of images is captured while the user is wearing a hearing aid,
applying a facial landmark algorithm on the plurality of images to identify a position of an ear of the user, at least one anatomic landmark of the ear and one or more parts of the hearing aid;
deriving, from the determined position of the at least one anatomic landmark of the ear of the user and from the one or more parts of the hearing aid, one or more features related to a relative position of the hearing aid vis-à-vis the at least one anatomic landmark of the ear of the user in the plurality of images;
determining the correctness of a position of the hearing aid by applying a machine learning algorithm on the one or more features, wherein the machine learning algorithm is trained using a training set comprising a large plurality of images of ears with hearing aids and a plurality of labels associated with the large plurality of images, each label indicating whether the hearing aid is correctly or incorrectly positioned, wherein the large plurality of images comprises images of ears of different subjects and wherein the large plurality of images comprises at least two images of each ear from different angles thereof, wherein the machine learning algorithm is trained to identify a need to change a structural element of the hearing aid; and
providing an indication to the user regarding the correctness of the position of the hearing aid, wherein:
if the position of the hearing aid is determined to be correct, provide an indication to the user that the hearing aid is correctly positioned;
if the position of the hearing aid is determined to be incorrect, request the user to reposition the hearing aid and/or change a structural element of the hearing aid followed by a recapturing of the plurality of images.

2. The method of claim 1, further comprising extracting the at least one anatomic landmark of the user's ear, wherein the extracting comprises applying an image analysis algorithm on the plurality of images.

3. The method of claim 2, wherein the at least one landmark comprises a climax of the helix, an angle of the pinna relative to the head, the crus of helix, the tragus, the intertragic notch, the antitragus, an entrance of the external auditory canal, the cavum and a d-shape of the pinna or any combination thereof.

4. The method of claim 1, wherein the one or more features comprises two or more of: a distance between a climax of a helix of the ear of the user and a connection point between a body and a tube of the hearing aid, a horizontal and/or vertical distance between an upper band of the tube of the hearing aid and a crus of the helix of the ear of the user, a horizontal and/or vertical distance between a middle band of the tube of the hearing aid and the cymba of the ear of the user, a horizontal position of the hearing aid tube and/or a dome of the hearing aid relative to the concha and/or the entrance of the external auditory meatus of the ear of the user, a position of a lower part of the hearing aid tube in a vertical and/or horizontal plane relative to a tragus, antitragus and/or intertragic notch of the ear of the user.

5. The method of claim 1, wherein the at least one side face image comprises at least one left-side face image and at least one right-side face image.

6. The method of claim 1, wherein the plurality of images are still images.

7. The method of claim 1, wherein the plurality of images are derived from a video.

8. The method of claim 1, wherein the request to reposition the hearing aid comprises instruction regarding how to reposition.

9. The method of claim 8, wherein the instructions comprises instructions to change an angle of a body of the hearing aid, instruction to position the hearing aid lower or higher than a current position, instruction regarding positioning of a wire/tube on the pinna, instructions regarding position and depth of a receiver/tube inside the ear and/or ear canal, instructions to change a dome of the hearing aid, instructions to change a length of a hearing aid tube and/or a receiver wire or any combination thereof.

10. The method of claim 1, wherein the structural element is selected from a tube length, a tube depth, a standard silicon dome size, a standard silicon dome type, or a custom made earmold.

11. The method of claim 1, wherein the method is executed via an App and wherein the capturing of the plurality of images is carried out using a camera of a mobile phone or tablet installed with the App.

12. The method of claim 11, wherein the method further comprises guiding the capturing of the plurality of images.

13. The method of claim 12, wherein the guiding comprises instructing the user to position the camera for capturing a frontal face image and determining correct face position relative to an image frame of the camera by applying a face recognition tool.

14. The method of claim 13, wherein the guiding further comprises instructing the user to turn the face sideways and determining correct face position based on automatic identification of the ear of the user.

15. The method of claim 1, further comprising an initial step of guided insertion/positioning of a hearing aid.

16. (canceled)

17. (canceled)

18. (canceled)

19. The method of claim 1, wherein the large plurality of images comprises a first image of an ear with a correctly positioned hearing aid and a second image of the same ear with an incorrectly positioned hearing aid.

20. The method of claim 1, further comprising extracting a plurality of features from each of the large plurality of images.

21. The method of claim 20, further comprising selecting a subset of features from the plurality of features, which subset have a predictive value above a predetermined threshold.

22. A system for determining hearing aid positioning correctness, the system comprising a processing logic configured to:
request a hearing aid user to capture a plurality of images, the plurality of images comprising at least one frontal face image and at least one side face image, wherein the plurality of images is captured while the user is wearing a hearing aid;
process the plurality of images to determine a position of at least one anatomic landmark of the user's ear and of one or more parts of the hearing aid, wherein the processing comprises applying a facial landmark algorithm on the plurality of images to identify a position of an ear of the user, at least one anatomic landmark of the ear and one or more parts of the hearing aid;
deriving, from the determined position of the at least one anatomic landmark of the ear of the user and from one or more parts of the hearing aid, one or more features related to a relative position of the hearing aid vis-à-vis the at least one anatomic landmark of the ear of the user in the plurality of images;
determine the correctness of a position of the hearing aid by applying a machine learning algorithm on the one or more derived features, wherein the machine learning algorithm is trained using a training set comprising a large plurality of images of ears with hearing aids and a plurality of labels associated with the large plurality of images, each label indicating whether the hearing aid is correctly or incorrectly positioned, wherein the large plurality of images comprises images of ears of different subjects and wherein the large plurality of images comprises at least two images of each ear from different angles thereof, wherein the machine learning algorithm is trained to identify a need to change a structural element of the hearing aid; and
provide an indication to the user regarding the correctness of the hearing aid position, wherein:
if the position of the hearing aid is determined to be correct, provide an indication to the user that the hearing aid is correctly positioned;
if the position of the hearing aid is determined to be incorrect, request the user to reposition the hearing aid and/or change a structural element of the hearing aid followed by a recapturing of the plurality of images.
